(19) United States
(12) Patent Application Publication
(10) Pub. No.: US 2022/0369017 A1
(43) Pub. Date: Nov. 17, 2022

(54) SOUND OUTPUT DEVICE

(71) Applicant: SONY GROUP CORPORATION, TOKYO (JP)

(72) Inventors: SOICHI TANAKA, TOKYO (JP); TAKAYUKI AKAI, KANAGAWA (JP)

(21) Appl. No.: 17/755,596

(22) PCT Filed: Nov. 9, 2020
(86) PCT No.: PCT/JP2020/041768

§ 371 Date: May 3, 2022

(30) Foreign Application Priority Data
Nov. 11, 2019 (JP) 2019-203744

(51) Int. Cl. H04R 1/10

(52) U.S. Cl. CPC H04R 1/1016; H04R 1/1041; H04R 1/1025; H04R 2420/07

(57) ABSTRACT

A housing that has a first portion and a second portion having outer shapes of different sizes, the first portion being larger in the outer shape than the second portion; and a speaker that is disposed inside the housing and outputs sound are included. The first portion has a first bulging portion and a second bulging portion, each of which bulges toward an outer peripheral side with respect to the second portion, and fitted to an ear is achieved with the first bulging portion partially inserted into a space ranging from an ear concha to an intertragic notch in each of inside a tragus and inside an antitragus, and the second bulging portion inserted into the ear concha inside an antihelix.

### TECHNICAL FIELD

The present technology relates to a technical field of a sound output device that is fitted to an ear and used to output sound.

### BACKGROUND ART

There are sound output devices that are fitted to ears to be used as headphones or earphones and output sound from speakers. In recent years, such sound output devices are increasing used in outdoor situations in addition to indoor situations. A sound output device includes a speaker that outputs sound to the inside and a control circuit board that controls driving of the speaker or the like disposed therein.

Some of such sound output devices have a device main body in which a speaker or the like is disposed and a fitting assisting body that assists fitting of the device main body to an auricle (see Patent Document 1 to Patent Document 4).

The sound output devices described in Patent Document 1 to Patent Document 4 are provided with a device main body in which a speaker is disposed therein and a fitting assisting body coupled to the device main body or formed integrally with the device main body. The fitting assisting body is referred to as an earmuff portion, a supporter, an anchor, an arm portion, or the like, and protrudes in a crooked state from the device main body.

In the sound output devices described in Patent Document 1 to Patent Document 4, the fitting assisting body is inserted into an ear concha, an outer peripheral surface of the fitting assisting body is placed on an anterior edge of an antihelix, and the fitting assisting body assists fitting of the device main body to an ear.

### CITATION LIST

### Patent Document

Patent Document 1: Japanese Patent Application Laid-Open No. 2019-146275
Patent Document 2: Japanese Patent Application Laid-Open No. 2019-145986
Patent Document 3: Japanese Patent Application Laid-Open No. 2018-186557
Patent Document 4: Japanese Patent Application Laid-Open No. 2017-98877

### SUMMARY OF THE INVENTION

### Problems to be Solved by the Invention

Incidentally, since human ears have individual differences in shape and size, there is a possibility that a user fitted with a sound output device may feel a sense of discomfort depending on the shape and size of a fitting assisting body. For example, in a case where the shape and size of the fitting assisting body of the sound output device to be fitted do not match the shape and size of the ear of the user, there is a possibility that the sound output device is in an unstable state where the sound output device easily falls off from the ear, or the fitting assisting body is inserted into a cavum conchae in a cramped state, and there is a possibility that a comfortable fitting feeling cannot be obtained and usability is reduced.

Furthermore, since the fitting assisting body protrudes from the device main body like an arm, there is a case where a sense of discomfort is generated when the sound output device is gripped, and there is also a problem in that the fitting assisting body is easily damaged when, for example, the fitting assisting body is accidentally dropped or brought into contact with another article, and again, there is a possibility that the usability is impaired.

On the other hand, in a sound output device as described above, it is desirable that a stable fitting state in a state of being fitted to an ear be obtained.

It is therefore an object of the sound output device of the present technology to improve usability and secure a state of stable fitting to an ear.

### Solutions to Problems

First, a sound output device according to the present technology includes: a housing that has a first portion and a second portion having outer shapes of different sizes, the first portion being larger in the outer shape than the second portion; and a speaker that is disposed inside the housing and outputs sound, in which the first portion has a first bulging portion and a second bulging portion, each of which bulges toward an outer peripheral side with respect to the second portion, and the sound output device is fitted to an ear with the first bulging portion partially inserted into a space ranging from an ear concha to an intertragic notch in each of inside a tragus and inside an antitragus, and the second bulging portion inserted into the ear concha inside an antihelix.

With this arrangement, fitting to the ear is achieved with the first bulging portion that bulges toward the outer peripheral side with respect to the second portion partially inserted into the space ranging from the ear concha to the intertragic notch in each of inside the tragus and inside the antitragus, and the second bulging portion that bulges toward the outer peripheral side with respect to the second portion inserted into the ear concha inside the antihelix.

Second, in the sound output device described above, it is desirable that the first bulging portion be partially pressed by each of the tragus and the antitragus, and the second bulging portion be pressed by the antihelix.

With this arrangement, the first bulging portion is pressed by the tragus and the antitragus in a state of being inserted into the intertragic notch and the ear concha, and the second bulging portion is pressed by the antihelix in a state of being inserted into the ear concha.

Third, in the sound output device described above, it is desirable that the first portion have an outer surface formed in a shape of a curved surface projecting outward.

With this arrangement, the outer surface formed in a shape of a curved surface projecting outward is pressed against each part of the ear.

Fourth, in the sound output device described above, it is desirable that the first portion be constituted by a first insertion portion positioned on the antitragus side and a second insertion portion positioned on the tragus side in a state where the sound output device is fitted to the ear, and the first portion be formed in an asymmetric shape in a direction in which the first insertion portion and the second insertion portion are continuous, and a maximum width of the first insertion portion be larger than a maximum width of the second insertion portion.

With this arrangement, the first portion is formed in a shape corresponding to the intertragic notch and the ear concha.

Fifth, in the sound output device described above, it is desirable that the housing be provided with a sound guiding tube having a sound guiding space that is continuous with the first portion, and the speaker be disposed inside the first portion.

With this arrangement, the speaker is disposed inside the first portion that is continuous with the sound guiding tube.

Sixth, in the sound output device described above, it is desirable that a battery be disposed inside the second portion, and the speaker and the battery be disposed in directions in such a way as to be the same in thickness direction.

With this arrangement, the housing is reduced in size in the direction in which the first portion and the second portion are continuous.

Seventh, in the sound output device described above, it is desirable that a magnet to be attracted to an attraction body disposed in a storage case in a state of being stored in the storage case be disposed inside the first portion, the speaker and the battery be disposed at positions shifted in a direction orthogonal to the thickness direction, and the magnet be disposed at a position facing the battery in the thickness direction.

With this arrangement, the magnet is disposed in a space between the speaker and the battery.

Eighth, in the sound output device described above, it is desirable that a portion on a side opposite to the first portion across the second portion be provided as a third portion, and an antenna for wireless communication be disposed inside the third portion.

With this arrangement, the antenna is disposed at a position spaced apart from the first portion to be inserted into the ear concha.

Ninth, in the sound output device described above, it is desirable that a control circuit board that controls at least the speaker and an antenna board on which the antenna is mounted be disposed inside the housing, and the control circuit board and the antenna board be disposed in directions in such a way as to be the same in thickness direction.

With this arrangement, the housing is reduced in size in the thickness direction of the control circuit board.

Tenth, in the sound output device described above, it is desirable that the control circuit board, the antenna board, and the speaker be disposed in directions in such a way as to be the same in thickness direction.

With this arrangement, the housing is further reduced in size in the thickness direction of the control circuit board.

### BRIEF DESCRIPTION OF DRAWINGS

FIG. 1 illustrates an embodiment of a sound output device and a fitting assisting body of the present technology together with FIGS. 2 to 13, and is a perspective view of an ear to which the sound output device is fitted.

FIG. 2 is a sectional view taken along line II-II in FIG. 1.

FIG. 3 is a front view of the sound output device.

FIG. 4 is a side view of the sound output device.

FIG. 5 is an exploded perspective view of the sound output device.

FIG. 6 is a perspective view of the sound output device illustrating an internal structure with a part thereof cut away.

FIG. 7 is a front view of the sound output device illustrating a position where each unit is disposed.

FIG. 8 is a conceptual diagram illustrating a first portion and a second portion.

FIG. 9 is a conceptual diagram illustrating a position of a boundary line with respect to a speaker and a battery.

FIG. 10 is a perspective view illustrating a state where the sound output device has been taken out from a storage case.

FIG. 11 is a view illustrating a state where the sound output device is stored in the storage case with a part thereof cut away.

FIG. 12 is a diagram illustrating a part of the sound output device in a state where the sound output device is fitted to the ear.

FIG. 13 is a diagram illustrating the entire sound output device in a state where the sound output device is fitted to the ear.

### MODE FOR CARRYING OUT THE INVENTION

Modes for carrying out a sound output device of the present technology will be described below with reference to the accompanying drawings. The sound output device of the present technology is used as a headphone or an earphone.

Note that the sound output device described below is provided with a speaker that functions as a sound output unit, and a sound guiding tube in which an internal space is formed as a passage (sound guiding space) of sound output from the speaker. Directions in the following description indicate the front, rear, upper, lower, left, and right directions with the axial direction of the sound guiding tube defined as a left-right direction.

Note that the front, rear, upper, lower, left, and right directions described below are for convenience of description, and implementation of the present technology is not limited to these directions.

<Structure of Ear>

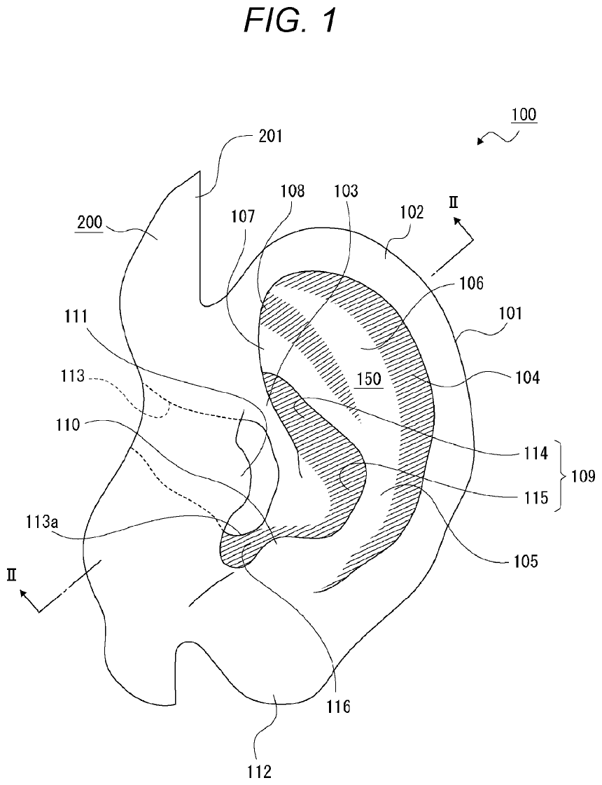

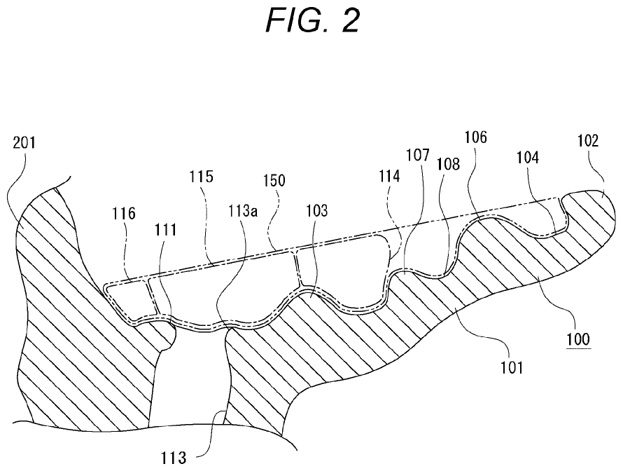

First, a structure of an ear to which the sound output device is fitted will be described (see FIGS. 1 and 2).

Ears 100 and 100 are parts of a head 200, and are constituted by corresponding auricles 101 and 101 and parts such as eardrums, semicircular canals, and cochleae that exist inside the head 200. Inner portions of the auricles 101 and 101 of the head 200 constitute corresponding temporal regions 201 and 201, and the auricles 101 and 101 protrude leftward or rightward from the corresponding temporal regions 201 and 201.

The auricle 101 is formed in a shallow concave shape opened substantially leftward or rightward as a whole so as to have an inner space 150, and has an outer peripheral portion having a portion referred to as a helix 102 and a projecting portion referred to as a crus helicis 103 that is continuous with the helix 102 and positioned in the vicinity of the temporal region 201.

An inner portion of the helix 102 is referred to as a scaphoid fossa 104 that forms a concave, and a lower portion that accounts for substantially half of the inside of the scaphoid fossa 104 is referred to as an antihelix 105 that forms a projection. A bifurcated projecting portion that is continuous with the antihelix 105 exists above the antihelix 105, and an outer portion and an inner portion of this bifurcated portion are referred to as a superior crus of antihelix 106 and an inferior crus of antihelix 107, respectively. A portion between the superior crus of antihelix 106 and the inferior crus of antihelix 107 is referred to as a triangular fossa 108 that forms a concave, and an inner portion of the antihelix 105 and the inferior crus of antihelix 107 is referred to as an ear concha 109 that forms a concave.

A portion that is continuous with the lower side of the antihelix 105 slightly bulges to the temporal region 201 side, and is referred to as an antitragus 110. A portion on the temporal region 201 side facing the antitragus 110 is referred to as a tragus 111 that slightly bulges to the antitragus 110 side, and a lower end portion that is continuous with the lower side of the helix 102 is referred to as an earlobe 112.

In a portion between the antitragus 110 and the tragus 111, there is an external acoustic opening 113a that is an entrance of an ear canal 113, and the ear canal 113 communicates with the eardrum, the semicircular canal, and the like.

In the inner space 150, a space surrounded by the inferior crus of antihelix 107 and the crus helicis 103 is referred to as a cymba conchae 114, a space below the cymba conchae 114 is referred to as a cavum conchae 115, and the cymba conchae 114 and the cavum conchae 115 are parts of the ear concha 109. The cavum conchae 115 communicates with the external acoustic opening 113a of the ear canal 113. In the inner space 150, a space that is continuous with the lower side of the cavum conchae 115 and opened in a U-shape is a space referred to as an intertragic notch 116.

The inner space 150 of the auricle 101 includes the cymba conchae 114, the cavum conchae 115, and the intertragic notch 116, and also includes a space lateral to the scaphoid fossa 104, the antihelix 105, the superior crus of antihelix 106, the inferior crus of antihelix 107, and the triangular fossa 108.

<Configuration of Sound Output Device>

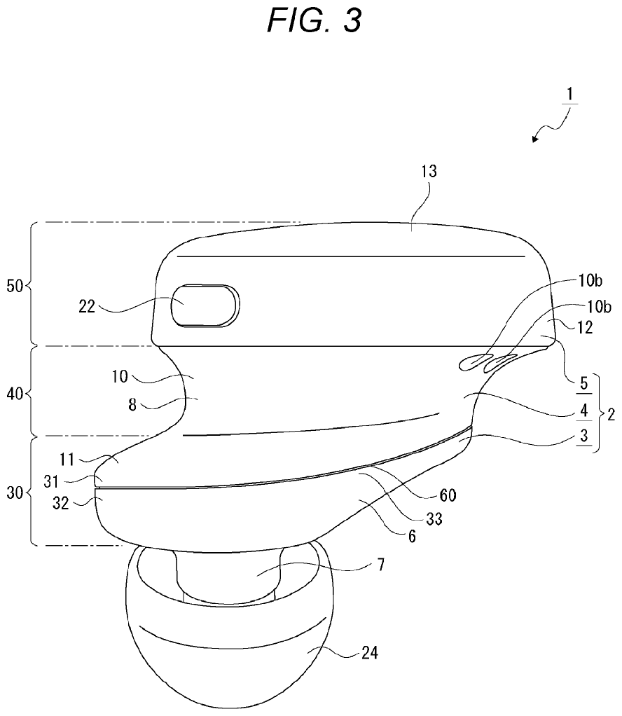

Next, a configuration of a sound output device 1 will be described (see FIGS. 3 to 9).

The sound output device 1 is used, for example, as a pair, one for the left ear and the other for the right ear. Note that one sound output device 1 may be used for listening to sound.

The sound output device 1 includes necessary units disposed inside a housing 2, and the housing 2 has a configuration in which a first case 3, a second case 4, and a third case 5 are sequentially coupled in the left-right direction (see FIGS. 3 to 7).

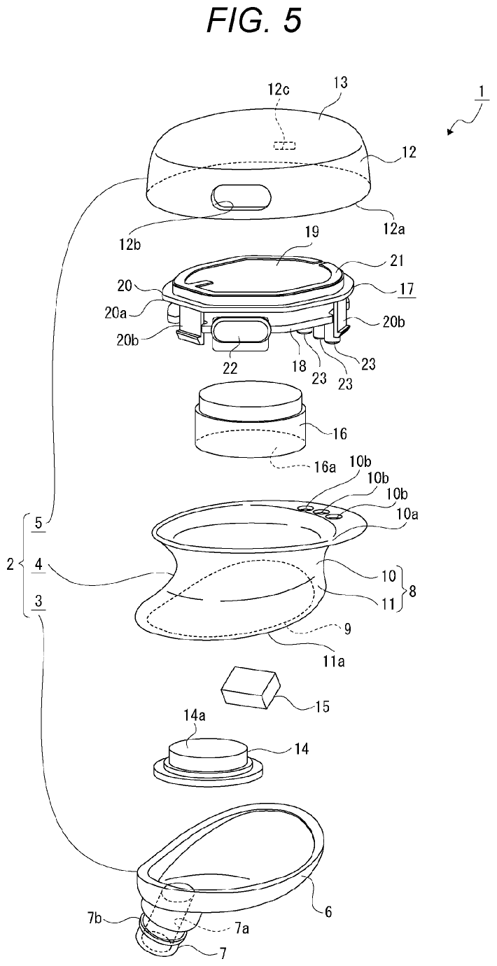

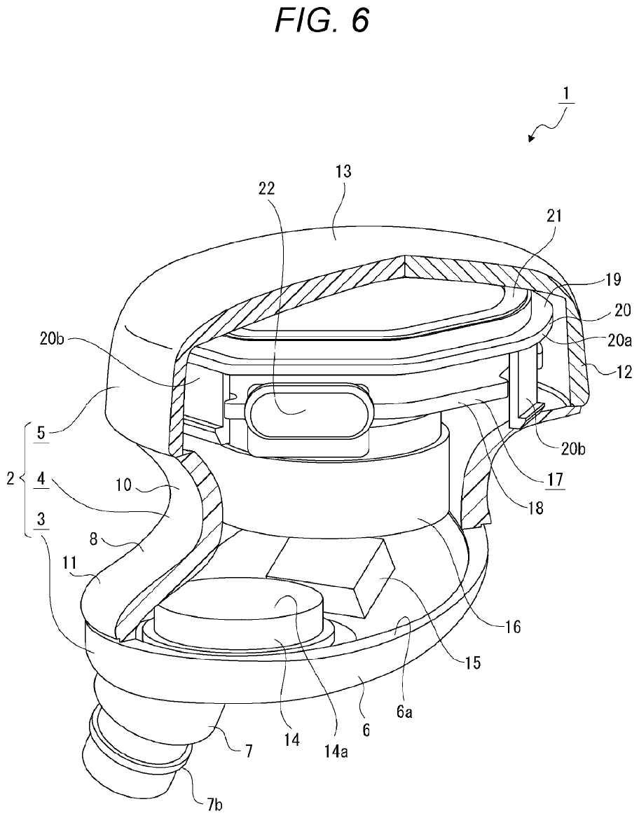

The first case 3 is formed by integrally forming a shallow dish-shaped case portion 6 opened to one side in the left-right direction and a sound guiding tube 7 protruding from the case portion 6 to the other side in the left-right direction (see FIGS. 5 and 6).

The entire outer surface of the case portion 6 is formed in a shape of a curved surface projecting outward. The case portion 6 is formed in a shape in which the outer shape becomes smaller from an edge 6a on the opening side toward the sound guiding tube 7.

The sound guiding tube 7 is formed in a substantially tubular shape with its axial direction substantially in the left-right direction, and has an internal space formed as a sound guiding space 7a. The sound guiding space 7a communicates with a space inside the case portion 6. An outer peripheral portion of the sound guiding tube 7 is provided with a coupling annular portion 7b having a diameter slightly larger than that of another portion, and the coupling annular portion 7b is positioned at a substantially central portion in the axial direction.

The second case 4 is formed in a shape having a recess opened on a side opposite to the first case 3, and has an outer peripheral surface portion 8 formed in an annular shape and a partition plate portion 9 having a substantially flat plate shape.

The entire outer surface of the outer peripheral surface portion 8 is formed in a shape of a curved surface. The outer peripheral surface portion 8 has a constricted portion 10 in which the outer shape is the smallest at a central portion in the axial direction and an outer shape changing portion 11 that is continuous with the constricted portion 10 and has an outer shape that becomes larger toward the first case 3.

In the outer peripheral surface portion 8, the constricted portion 10 and the outer diameter changing portion 11 are positioned so as to be displaced in a direction orthogonal to the left-right direction. An edge 10a of the constricted portion 10 on a side opposite to the outer diameter changing portion 11 and an edge 11a of the outer diameter changing portion 11 on a side opposite to the constricted portion 10 are positioned so as not to overlap in the left-right direction.

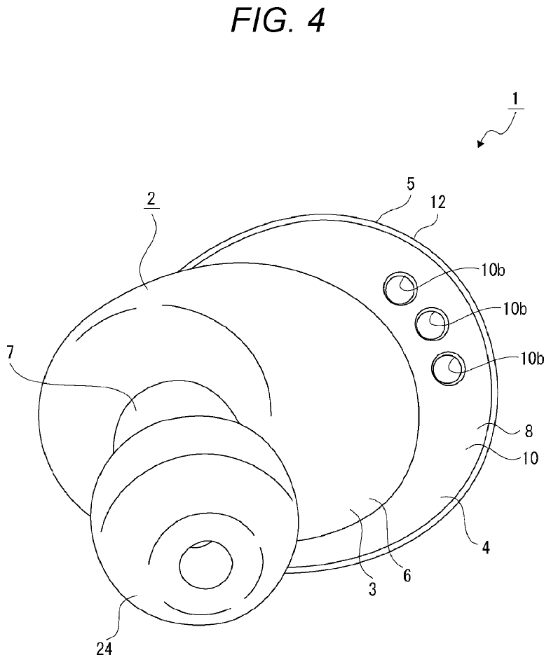

Terminal disposition holes 10b, 10b, and 10b penetrating substantially in the left-right direction are formed side by side in a circumferential direction at an end portion of the constricted portion 10 on a side opposite to the partition plate portion 9 (see FIGS. 3 and 4). The shape and size of the edge 11a of the outer diameter changing portion 11 are substantially the same as the shape and size of the edge 6a of the case portion 6 (see FIGS. 5 and 6).

A cable insertion hole (not illustrated) is formed in the partition plate portion 9.

The third case 5 is formed in a shape having a recess opened to the second case 4 side, and has a circumferential portion 12 formed in an annular shape and a cover surface portion 13 having an outer peripheral portion that is continuous with one edge of the circumferential portion 12. The entire outer surface of the third case 5 is formed in a shape of a curved surface projecting outward.

The circumferential portion 12 is formed in a substantially toric shape, and the shape and size of an edge 12a on a side opposite to the cover surface portion 13 are substantially the same as the shape and size of the edge 10a in the constricted portion 10. In the circumferential portion 12, a button disposition hole 12b and a microphone hole 12c are formed to be spaced apart in the circumferential direction.

The cover surface portion 13 is formed in a substantially circular shape, and is formed in a shape of a gently curved surface projecting toward the outer surface side.

The housing 2 has a configuration in which the edge 6a of the case portion 6 in the first case 3 and the edge 11a of the outer diameter changing portion 11 in the second case 4 are coupled by bonding or the like, and the edge 10a of the constricted portion 10 in the second case 4 and the edge 12a of the peripheral surface portion 12 in the third case 5 are coupled by bonding or the like (see FIGS. 3 and 4).

A speaker 14 and a magnet 15 are disposed inside the case portion 6 in the first case 3 (see FIGS. 5 to 7). The speaker 14 is formed in a flat rotationally symmetric shape with its thickness direction (axial direction) in the left-right direction. The speaker 14 is disposed at a position where the speaker 14 caps the sound guiding space 7a of the sound guiding tube 7. The magnet 15 is disposed at a position spaced apart from the sound guiding space 7a. Note that the speaker 14 may be downsized and disposed in the sound guiding space 7a.

In a state where the sound output device 1 is stored in a storage case described later for storing the sound output device 1, the magnet 15 is attracted to an attraction body disposed in the storage case. Thus, a stable storage state of the sound output device 1 with respect to the storage case is secured by the magnet 15 being attracted to the attraction body.

A battery 16 is disposed inside the second case 4. The battery 16 is formed in a substantially cylindrical shape with its thickness direction (axial direction) in the left-right direction. The battery 16 is disposed in a direction in which the thickness direction is the same as that of the speaker 14. The battery 16 is disposed at a position shifted from the speaker 14 in a direction orthogonal to the thickness direction, and is disposed at a position facing the magnet 15 in the left-right direction.

As described above, since the speaker 14 and the battery 16 are disposed at positions shifted in the direction orthogonal to the thickness direction and the magnet 15 is disposed at a position facing the battery 16 in the thickness direction, the magnet 15 is disposed in a space between the speaker 14 and the battery 16, and the sound output device 1 can be downsized by effective use in a space inside the housing 2.

A board unit 17 is disposed inside the third case 5. The board unit 17 has a control circuit board 18, an antenna board 19, and a holding bracket 20.

The control circuit board 18 is formed in a substantially disk shape with its thickness direction in the left-right direction that is slightly smaller than the circumferential portion 12 of the third case 5. The control circuit board 18 is a board that controls each unit disposed inside the housing 2, for example, the speaker 14 or the battery 16, and is disposed so as to face the battery 16.

The antenna board 19 is formed in a substantially disk shape with its thickness direction in the left-right direction that is slightly smaller than the circumferential portion 12 of the third case 5. The antenna board 19 is disposed so as to face the control circuit board 18 in the left-right direction, and is positioned closer to the cover surface portion 13 than the control circuit board 18. An antenna 21 is mounted on a surface of the antenna board 19 on the cover surface portion 13 side. The antenna 21 is mounted on an outer peripheral portion of the antenna board 19, for example, and has a function of performing wireless communication by transmitting and receiving sound signals.

The holding bracket 20 has an attachment plate portion 20a formed in a plate shape that faces the left-right direction, and engagement protrusions 20b, 20b, and 20b that protrude in the thickness direction of the attachment plate portion 20a from an outer peripheral portion of the attachment plate portion 20a. The engagement protrusions 20b, 20b, and 20b are positioned spaced apart in the circumferential direction. The antenna board 19 is attached to the attachment plate portion 20a of the holding bracket 20. The engagement protrusions 20b, 20b, and 20b of the holding bracket 20 are positioned on the outer peripheral side of the control circuit board 18, and have distal ends engaged with the second case 4 or the third case 5.

The engagement protrusions 20b, 20b, and 20b of the holding bracket 20 are engaged with the second case 4 or the third case 5 so that the holding bracket 20 is set at a predetermined position inside the third case 5, and the antenna 21 mounted on the antenna board 19 attached to the holding bracket 20 is positioned with respect to the third case 5. Thus, the antenna 21 is positioned at a position adjacent to the cover surface portion 13.

Each one of a plurality of connection cables (not illustrated) has one end connected to the control circuit board 18, and the other end connected to the speaker 14, the battery 16, or the antenna board 19. A part of the connection cable connected to the speaker 14 is inserted through the cable insertion hole of the partition plate portion 9.

As described above, in the sound output device 1, the control circuit board 18 and the antenna board 19 are disposed inside the housing 2, and the control circuit board 18 and the antenna board 19 are disposed in directions in such a way as to be the same in thickness direction.

Thus, the housing 2 is reduced in size in the thickness direction (left-right direction) of the control circuit board 18, and the sound output device 1 can be downsized.

Furthermore, the control circuit board 18, the antenna board 19, the speaker 14, and the battery 16 are also disposed in directions in which thickness directions are in the same direction.

Thus, the housing 2 is further reduced in size in the thickness direction of the control circuit board 18, and the sound output device 1 can be further downsized.

Each circuit formed on the control circuit board 18 is connected with a power button 22 and a microphone (not illustrated), and the power button 22 and the microphone are positioned on the outer peripheral side of the control circuit board 18 so as to be spaced apart from each other in the circumferential direction. The power button 22 is disposed so as to be inserted into the button disposition hole 12b of the third case 5, and the microphone is disposed at a position corresponding to the microphone hole 12c of the third case 5.

Connection terminals 23, 23, and 23 are connected to a surface of the control circuit board 18 opposite to the antenna board 19. The connection terminals 23, 23, and 23 are connected to an outer peripheral portion of the control circuit board 18 so as to be arranged side by side in the circumferential direction, and protrude from the control circuit board 18 in the thickness direction of the control circuit board 18. Distal end portions of the connection terminals 23, 23, and 23 are inserted into the corresponding terminal disposition holes 10b, 10b, and 10b of the second case 4.

Note that, in the sound output device 1, entry of moisture into the housing 2 through the button disposition hole 12b, the microphone hole 12c, the terminal disposition holes 10b, 10b, and 10b, and the sound guiding tube 7 is prevented by, for example, a waterproof sheet (not illustrated).

An ear pad 24 formed with the use of, for example, a rubber material is attached to the sound guiding tube 7 of the second case 4. The ear pad 24 can be attached to and detached from the sound guiding tube 7. In a state of being attached to the sound guiding tube 7, the ear pad 24 is partially engaged with the coupling annular portion 7b of the sound guiding tube 7 so as to be stably attached to the sound guiding tube 7 without easily falling off from the sound guiding tube 7.

Note that the sound output device 1 may have a configuration without the ear pad 24.

In the sound output device 1 configured as described above, the case portion 6 of the first case 3 and the outer diameter changing portion 11 of the second case 4 constitute a first portion 30, the constricted portion 10 of the second case 4 constitutes a second portion 40, and a portion on a side opposite to the first portion 30 across the second portion 40 constitutes a third portion 50 (see FIGS. 3, 7, and 8).

The first portion 30 has an outer surface 30a formed in a shape of a curved surface projecting outward. The first portion 30 is a portion to be inserted into a space ranging from the ear concha 109 to the intertragic notch 116 in a state where the sound output device 1 is fitted to the ear 100.

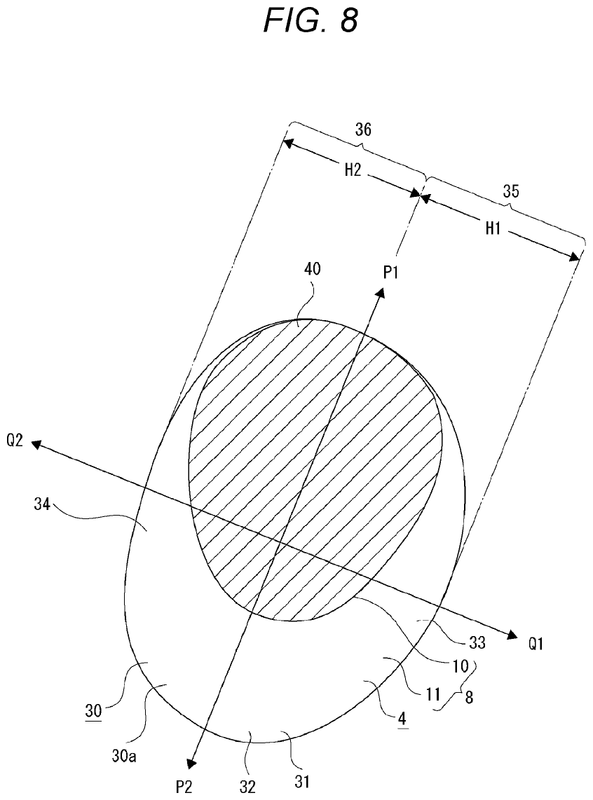

Both the first portion 30 and the second portion 40 are formed in a substantially elliptical shape or a shape close to an elliptical shape when viewed from the left-right direction, and the first portion 30 has an outer shape larger than that of the second portion 40 (see FIG. 8). The first portion 30 is provided with a protruding portion 31 that protrudes outward in a direction orthogonal to the left-right direction with respect to the second portion 40. In the elliptical shapes, when major axis directions are expressed by P1 and P2 and minor axis directions are expressed by Q1 and Q2, the protruding portion 31 protrudes outward with respect to the second portion 40 in the entire circumferential direction other than directions excluding the major axis direction P1. The protruding portion 31 is constituted by a first bulging portion 32 that bulges toward the major axis direction P2 side, a second bulging portion 33 that bulges toward the minor axis direction Q1 side, and a third bulging portion 34 that bulges toward the minor axis direction Q2 side.

The first portion 30 is formed in a shape asymmetric with respect to the major axis directions P1 and P2 as viewed from the left-right direction, and is constituted by a first insertion portion 35 positioned on the minor axis direction Q1 side and a second insertion portion 36 positioned on the minor axis direction Q2 side. A degree of bulging of the first insertion portion 35 with respect to the second portion 31 is larger than that of the second insertion portion 36, and a maximum width H1 of the first insertion portion 35 is larger than a maximum width H2 of the second insertion portion 36 in a direction in which the first insertion portion 35 and the second insertion portion 36 are continuous.

As described above, the first portion 30 is constituted by the case portion 6 of the first case 3 and the outer diameter changing portion 11 of the second case 4, and also includes the edge 6a of the case portion 6 and the edge 11a of the outer diameter changing portion 11. A portion where the edge 6a of the case portion 6 and the edge 11a of the outer diameter changing portion 11 are coupled is formed as a boundary line 60 between the first case 3 and the second case 4, and the boundary line 60 is formed in a three-dimensional curve (see FIGS. 3, 7, and 9).

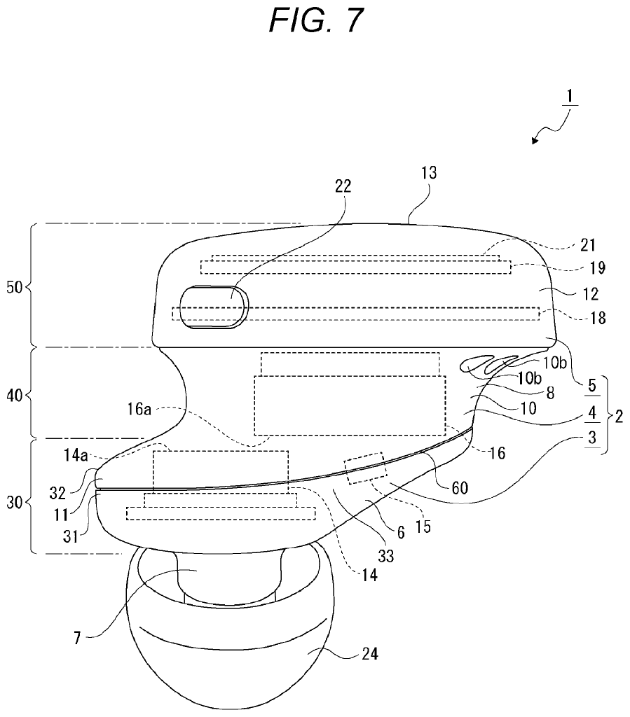

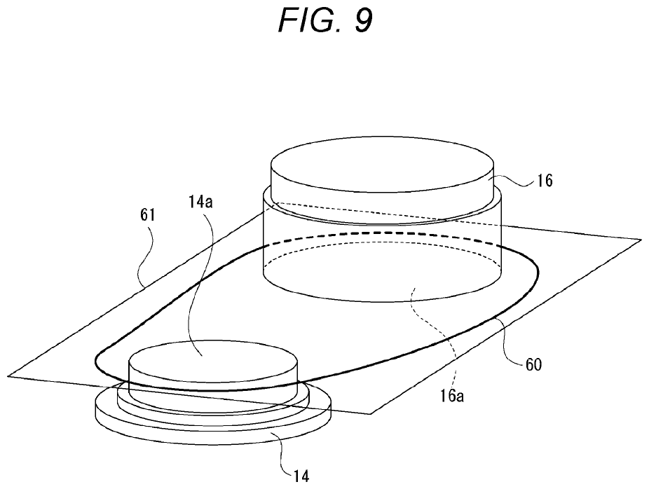

In the sound output device 1, the speaker 14 is disposed inside the first portion 30, the battery 16 is disposed inside the second portion 40, and the speaker 14 and the battery 16 are disposed at positions spaced apart in the left-right direction and also spaced apart in a direction orthogonal to the left-right direction (see FIGS. 7 and 9). At this time, an end surface 14a of the speaker 14 on the side opposite to the sound guiding tube 7 in the left-right direction and an end surface 16a of the battery 16 on the side facing the magnet 15 are located at substantially the same position or positions adjacent to each other.

Assuming that a surface including the end surface 14a of the speaker 14 and the end surface 16a of the battery 16 is a shared plane 61, the boundary line 60 is included in the shared plane 61 or located at a position adjacent to the shared plane 61 from a position along the outer periphery of the speaker 14 to a position along the outer periphery of the battery 16, and is a three-dimensional curve connecting the maximum outer shape of the first portion 30.

<Storage Case>

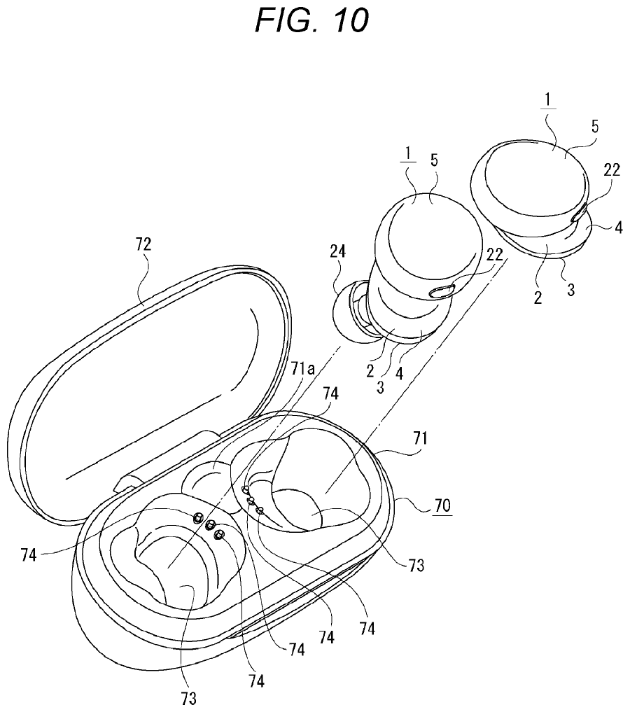

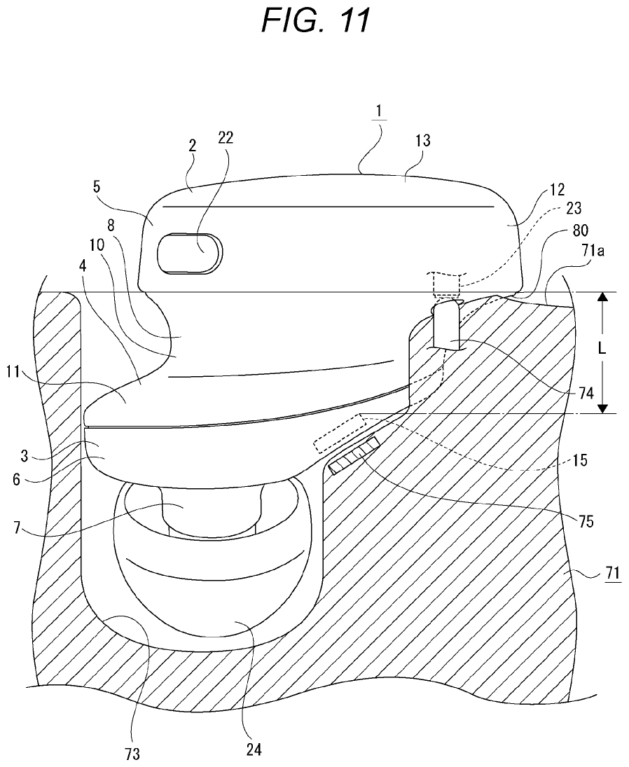

Next, a storage case 70 in which the sound output device 1 is stored will be described (see FIGS. 10 and 11).

The storage case 70 has a case body 71 into which the sound output devices 1 and 1 are inserted and a cover body 72 for opening and closing the case body 71, and the cover body 72 is rotatably supported by the case body 71. The storage case 70 has a power supply terminal (not illustrated) for receiving electric power, and also functions as a charger for charging the batteries 16 and 16 of the sound output devices 1 and 1.

Storage recesses 73 and 73 are formed in the case body 71, one of the storage recesses 73 for storing the sound output device 1 for the left ear 100, and the other storage recess 73 for storing the sound output device 1 for the right ear 100. In the case body 71, an extraction recess 71a is formed between the storage recesses 73 and 73. Note that the sound output device 1 for the left ear 100 and the sound output device 1 for the right ear 100 are formed in a symmetrical shape.

Terminal portions 74, 74, and 74 that function as charging terminals are disposed in the case body 71, and the terminal portions 74, 74, and 74 are positioned side by side in the circumferential direction so as to be partially exposed from an opening edge of the storage recess 73.

An attraction body 75 is disposed inside the case body 71 (see FIG. 11). The attraction body 75 is a magnetic body such as a magnet or metal, and is disposed at a position closer to the back side than the opening of the storage recess 73 and near the storage recess 73.

Note that, although an example in which the magnet 15 is provided in the sound output device 1 has been described above, in a case where a magnet is provided as the attraction body 75 in the storage case 70, a magnetic body may be provided in the sound output device 1 instead of the magnet 15.

In a state where the cover body 72 is opened, the sound output device 1 excluding a part thereof is inserted into the storage recess 73, and thus the sound output device 1 is stored and held in the storage case 70. When the sound output device 1 is inserted into the storage recess 73, the magnet 15 is attracted by the attraction body 75, and thus the sound output device 1 is held in the case body 71.

In a state where the sound output device 1 is held in the case body 71, the third case 5 is brought into a state of protruding from the storage recess 73, and a gap 80 is formed between the extraction recess 71a and the third case 5. Furthermore, in a state where the sound output device 1 is held in the case body 71, the terminal portions 74, 74, and 74 are inserted into the corresponding terminal disposition holes 10b, 10b, and 10b of the second case 4, and the terminal portions 74, 74, and 74 are connected to the corresponding connection terminals 23, 23, and 23, so that the battery 16 can be charged.

The sound output device 1 is protected by the case body 71 being blocked by the cover body 72.

The sound output device 1 can be taken out from the case body 71 by inserting a finger into the gap 80 formed between the extraction recess 71a and the third case 5 and picking up the sound output device 1.

At this time, there is a certain distance L between the gap 80 into which a finger is to be inserted and the magnet 15 attracted to the attraction body 75. As described above, since the gap 80 and the magnet 15 are not positioned in proximity to each other, the distance L is set to a sufficient length, and the portion where the sound output device 1 is attracted to the attraction body 75 and the portion into which the finger is inserted are sufficiently separated from each other, it is possible to cancel the state of the magnet 15 being attracted to the attraction body 75 with a small force by using the attracted portion as a fulcrum and the portion into which the finger is inserted as a point of effort.

Thus, due to the distance L, the sound output device 1 can be easily and reliably taken out from the case body 71.

<Fitting Sound Output Device to Ear>

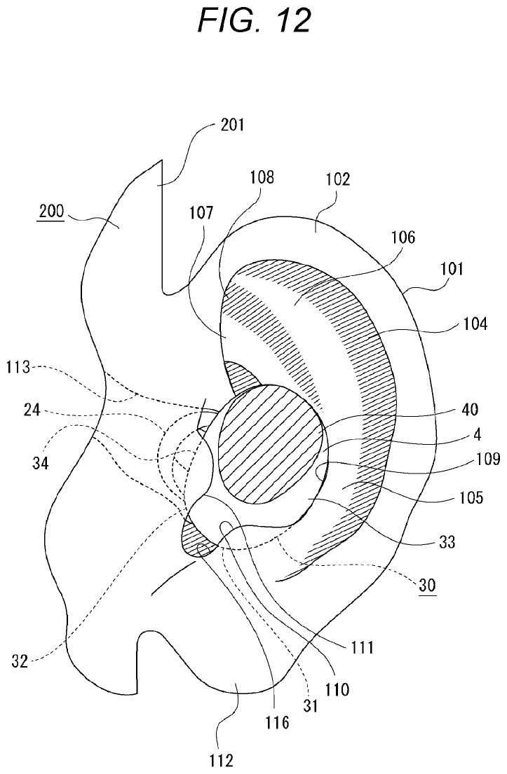

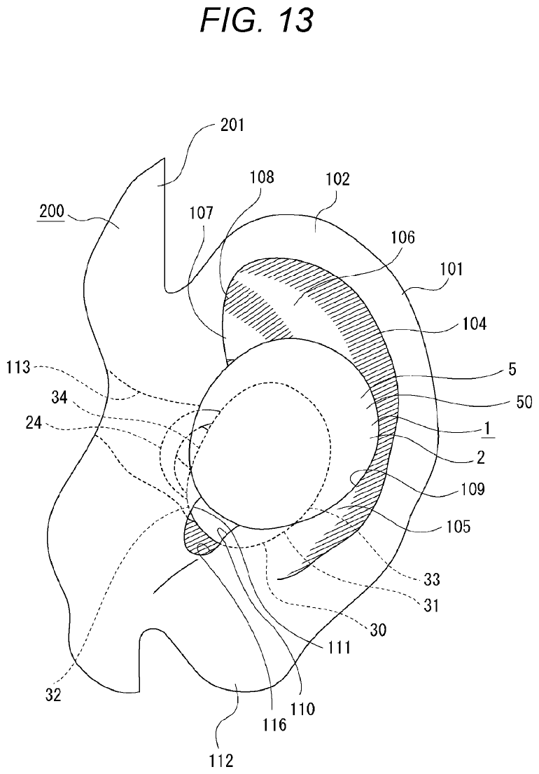

Next, a state where the sound output device 1 is fitted to the ear 100 will be described (see FIGS. 12 and 13). Note that, in the following, a state of being fitted to the left ear 100 will be described as an example.

In a state where the sound output device 1 is fitted to the ear 100, the sound guiding tube 7 and the ear pad 24 are inserted into the space ranging from the ear concha 109 to the intertragic notch 116, and a part of the ear pad 24 is inserted into the ear canal 113. At this time, the first portion 30 is also inserted into the space ranging from the ear concha 109 to the intertragic notch 116.

The first bulging portion 32 is partially inserted into each of the inside of the tragus 111 and the inside of the antitragus 110, and the second bulging portion 33 and the third bulging portion 34 are inserted into the ear concha 109. The first bulging portion 32 is pressed by the tragus 111 and the antitragus 110, the second bulging portion 33 is pressed by the antihelix 105, and the first portion 30 is pressed by each of the three portions of the ear 100.

In a state where the sound output device 1 is fitted to the ear 100 as described above, the first bulging portion 32 is partially pressed by each of the tragus 111 and the antitragus 110, and the second bulging portion 33 is pressed by the antihelix 105.

Thus, in a state of being inserted into the intertragic notch 116 and the ear concha 109, the first bulging portion 32 is pressed by the tragus 111 and the antitragus 110. At the same time, in a state of being inserted into the ear concha 109, the second bulging portion 33 is pressed by the antihelix 105. Thus, it is possible to secure a state where the sound output device 1 is stably fitted to the ear 100.

Furthermore, in the sound output device 1, since the outer surface 30a of the first portion 30 to be inserted into the intertragic notch 116 and the ear concha 109 is formed in a shape of a curved surface projecting outward, the outer surface 30a formed in a shape of a curved surface projecting outward is pressed against each part of the ear 100. Thus, it is possible to secure a state where the sound output device 1 is comfortably fitted to the ear 100 without causing a sense of discomfort.

Moreover, the first portion 30 is constituted by the first insertion portion 35 positioned on the antitragus 110 side and the second insertion portion 36 positioned on the tragus 111 side in a state of being fitted to the ear 100. The first portion 30 is formed in an asymmetric shape in the direction in which the first insertion portion 35 and the second insertion portion 36 are continuous, and the maximum width H1 of the first insertion portion 35 is larger than the maximum width H2 of the second insertion portion 36.

Thus, since the first portion 30 is formed in a shape corresponding to the intertragic notch 116 and the ear concha 109, it is possible to secure a state where the sound output device 1 is stably and more comfortably fitted to the ear 100.

<Summary>

As described above, in the sound output device 1, the first portion 30 is provided with the first bulging portion 32 and the second bulging portion 33, each of which bulges toward the outer peripheral side with respect to the second portion 40, and the sound output device 1 is fitted to the ear 100 with the first bulging portion 32 partially inserted into the space ranging from the ear concha 109 to the intertragic notch 116 in each of inside the tragus 111 and inside the antitragus 110, and the second bulging portion 33 inserted into the ear concha 109 inside the antihelix 105.

Thus, the sound output device 1 is fitted to the ear 100 with the first bulging portion 32 that bulges toward the outer peripheral side with respect to the second portion 40 partially inserted into the intertragic notch 116 in each of inside the tragus 111 and inside the antitragus 110, and the second bulging portion 33 that bulges toward the outer peripheral side with respect to the second portion 40 inserted into the ear concha 109 inside the antihelix 105.

With this arrangement, the sound output device 1 is fitted to the ear 100 without a fitting assisting body that protrudes like an arm, and this makes it possible to obtain a comfortable fitting feeling, improve usability, and secure a state of stable fitting to the ear 100.

Furthermore, the housing 2 is provided with the sound guiding tube 7 having the sound guiding space 7a that is continuous with the first portion 30, and the speaker 14 is disposed inside the first portion 30.

Thus, since the speaker 14 is disposed inside the first portion 30 that is continuous with the sound guiding tube 7, it is possible to secure a sufficient space for disposing the speaker 14 inside the housing 2 and also secure a good state of sound output.

Moreover, the battery 16 is disposed inside the second portion 40, and the speaker 14 and the battery 16 are disposed in directions in such a way as to be the same in thickness direction.

Thus, the housing 2 is reduced in size in the direction in which the first portion 30 and the second portion 40 are continuous, and the sound output device 1 can be downsized.

Furthermore, a portion on a side opposite to the first portion 30 across the second portion 40 is provided as the third portion 50, and the antenna 21 for wireless communication is disposed inside the third portion 50.

Thus, since the antenna 21 is disposed at a position spaced apart from the first portion 30 to be inserted into the ear concha 109, it is possible to secure a good state of input and output of signals to and from the antenna 21.

<Present Technology>

The present technology may have the following configurations.

(1)

A sound output device including:

a housing that has a first portion and a second portion having outer shapes of different sizes, the first portion being larger in the outer shape than the second portion; and

a speaker that is disposed inside the housing and outputs sound, in which

the first portion has a first bulging portion and a second bulging portion, each of which bulges toward an outer peripheral side with respect to the second portion, and

the sound output device is fitted to an ear with the first bulging portion partially inserted into a space ranging from an ear concha to an intertragic notch in each of inside a tragus and inside an antitragus, and the second bulging portion inserted into the ear concha inside an antihelix.

(2)

The sound output device according to (1), in which

the first bulging portion is partially pressed by each of the tragus and the antitragus, and the second bulging portion is pressed by the antihelix.

(3)

The sound output device according to (1) or (2), in which

the first portion has an outer surface formed in a shape of a curved surface projecting outward.

(4)

The sound output device according to any one of (1) to (3), in which

the first portion is constituted by a first insertion portion positioned on the antitragus side and a second insertion portion positioned on the tragus side in a state where the sound output device is fitted to the ear, and

the first portion is formed in an asymmetric shape in a direction in which the first insertion portion and the second insertion portion are continuous, and a maximum width of the first insertion portion is larger than a maximum width of the second insertion portion.

(5)

The sound output device according to any one of (1) to (4), in which

the housing is provided with a sound guiding tube having a sound guiding space that is continuous with the first portion, and

the speaker is disposed inside the first portion.

(6)

The sound output device according to (5), in which

a battery is disposed inside the second portion, and

the speaker and the battery are disposed in directions in such a way as to be the same in thickness direction.

(7)

The sound output device according to (6), in which

a magnet to be attracted to an attraction body disposed in a storage case in a state of being stored in the storage case is disposed inside the first portion,

the speaker and the battery are disposed at positions shifted in a direction orthogonal to the thickness direction, and

the magnet is disposed at a position facing the battery in the thickness direction.

(8)

The sound output device according to any one of (1) to (7), in which

a portion on a side opposite to the first portion across the second portion is provided as a third portion, and

an antenna for wireless communication is disposed inside the third portion.

(9)

The sound output device according to (8), in which

a control circuit board that controls at least the speaker and an antenna board on which the antenna is mounted are disposed inside the housing, and

the control circuit board and the antenna board are disposed in directions in such a way as to be the same in thickness direction.

(10)

The sound output device according to (9), in which

the control circuit board, the antenna board, and the speaker are disposed in directions in such a way as to be the same in thickness direction.

### REFERENCE SIGNS LIST

100 Ear
105 Antihelix
109 Ear concha
110 Antitragus
111 Tragus
116 Intertragic notch
1 Sound output device
2 Housing
7 Sound guiding tube
7a Sound guiding space
14 Speaker
15 Magnet
16 Battery
18 Control circuit board
19 Antenna board
21 Antenna
30 First insertion portion
30a Outer surface
31 Protruding portion
32 First bulging portion
33 Second bulging portion
35 First insertion portion
36 Second insertion portion
40 Second portion
50 Third portion
70 Storage case
75 Attraction body

1. A sound output device comprising:
a housing that has a first portion and a second portion having outer shapes of different sizes, the first portion being larger in the outer shape than the second portion; and
a speaker that is disposed inside the housing and outputs sound, wherein
the first portion has a first bulging portion and a second bulging portion, each of which bulges toward an outer peripheral side with respect to the second portion, and
the sound output device is fitted to an ear with the first bulging portion partially inserted into a space ranging from an ear concha to an intertragic notch in each of inside a tragus and inside an antitragus, and the second bulging portion inserted into the ear concha inside an antihelix.

2. The sound output device according to claim 1, wherein
the first bulging portion is partially pressed by each of the tragus and the antitragus, and the second bulging portion is pressed by the antihelix.

3. The sound output device according to claim 1, wherein
the first portion has an outer surface formed in a shape of a curved surface projecting outward.

4. The sound output device according to claim 1, wherein
the first portion is constituted by a first insertion portion positioned on the antitragus side and a second insertion portion positioned on the tragus side in a state where the sound output device is fitted to the ear, and
the first portion is formed in an asymmetric shape in a direction in which the first insertion portion and the second insertion portion are continuous, and a maximum width of the first insertion portion is larger than a maximum width of the second insertion portion.

5. The sound output device according to claim 1, wherein
the housing is provided with a sound guiding tube having a sound guiding space that is continuous with the first portion, and
the speaker is disposed inside the first portion.

6. The sound output device according to claim 5, wherein
a battery is disposed inside the second portion, and
the speaker and the battery are disposed in directions in such a way as to be the same in thickness direction.

7. The sound output device according to claim 6, wherein
a magnet to be attracted to an attraction body disposed in a storage case in a state of being stored in the storage case is disposed inside the first portion,
the speaker and the battery are disposed at positions shifted in a direction orthogonal to the thickness direction, and
the magnet is disposed at a position facing the battery in the thickness direction.

8. The sound output device according to claim 1, wherein
a portion on a side opposite to the first portion across the second portion is provided as a third portion, and
an antenna for wireless communication is disposed inside the third portion.

9. The sound output device according to claim 8, wherein
a control circuit board that controls at least the speaker and an antenna board on which the antenna is mounted are disposed inside the housing, and
the control circuit board and the antenna board are disposed in directions in such a way as to be the same in thickness direction.

10. The sound output device according to claim 9, wherein
the control circuit board, the antenna board, and the speaker are disposed in directions in such a way as to be the same in thickness direction.
